(19) United States
(12) Patent Application Publication
(10) Pub. No.: US 2020/0136848 A1
(43) Pub. Date: Apr. 30, 2020

(54) METHOD FOR CONTROLLING A SMART HOME APPLICANCE

(71) Applicant: KYE SYSTEMS CORP., New Taipei City (TW)

(72) Inventor: Chi-Wai CHAN, New Taipei City (TW)

(73) Assignee: KYE SYSTEMS CORP., New Taipei City (TW)

(21) Appl. No.: 16/169,864

(22) Filed: Oct. 24, 2018

(51) Int. Cl. H04L 12/28; G06F 9/4401

(52) U.S. Cl. CPC H04L 12/282; G06F 9/4411; H04L 12/2814; H04L 12/281

(57) ABSTRACT

A smart home appliance controlling method that is applicable to a smart home appliance device, a computer peripheral device and a computer, and the smart home appliance device controlling method includes: executing an import program to obtain a smart home appliance configuration file, and operating the computer periphery to send a control operation after obtaining the smart home appliance configuration file, and the processing unit generates a control command according to the control operation and the smart home appliance configuration file, the communication unit sends a control packet according to the control command and a communication protocol, and the smart home appliance receives the control packet, and executes a control command in the control packet.

### BACKGROUND

### Technical Field

The present disclosure is related to controlling smart home appliances, and more particularly to a method of controlling smart home appliances using computer peripheral devices.

### Related Art

With the advancement of science and technology, smart home appliances are increasingly popular in the homes of ordinary people. On the other hand, whether in the company or at home, personal computers (PCs) have become an indispensable necessity for modern people.

However, when using a personal computer to work or play games at home, it is often just to control the indoor lighting, air conditioning temperature, or enable a certain home appliance, but must leave the computer, stop the current progress and also spread the user's original focus. Moreover, every home appliance in home usually has a corresponding remote control, such as a cold air remote control, a television remote control, and things alike. Users often spend extra time finding the remote controller they need, and they can adjust the state of the appliance through the controller. The above-mentioned time cannot be ignored to affect the progress of the work or the progress of the instant game. And too many remote controls scattered around the home, which is too messy and has a poor visual perception.

### SUMMARY

In view of this, the present disclosure proposes a method of controlling a smart home appliance by a computer peripheral device, thereby saving the user extra time spent operating the smart home appliance.

The smart home appliance control method according to an embodiment of the present disclosure is applicable to a smart home appliance device, a computer peripheral device, and a computer, and the smart home appliance device control method includes: executing an import program to obtain a smart home appliance configuration file; after the appliance configuration file, the computer peripheral device is operated to send a control operation; the processing unit generates a control command according to the control operation and the smart home appliance profile; the communication unit sends the control packet according to the control command and the communication protocol; and the smart home device receives the control packet and executes the control instructions in the packet.

According to an embodiment of the present disclosure, a smart home appliance control method is disclosed in which a smart home appliance and a computer are all connected to a network, and the importing program includes: connecting a computer peripheral device to a computer; using the embedded program to detect whether there is a smart home device connected to the network; the embedded program obtains the identification code of the smart home device connected to the network; and the embedded program checks whether there is a custom smart home appliance configuration file corresponding to the identification code, wherein when there is a custom smart appliance configuration file, the embedded program uses the customized smart appliance configuration file as the smart appliance configuration file; or when there is no custom smart appliance configuration file, the embedded program uses the default smart home appliance configuration file is used as a smart home appliance configuration file.

According to another embodiment of the present disclosure, a method for controlling a smart home appliance includes: a computer peripheral device and a smart home device each performing a pairing process to establish a pairing connection between a computer peripheral device and a smart home device, wherein the pairing process includes: selectively transmitting or receiving the paired broadcast signal; and after the paired broadcast signal is received, establishing a pairing connection; after the pairing connection is established, checking whether the temporary storage unit of the computer peripheral device has the smart home appliance profile; when the temporary storage unit does not have the smart home appliance configuration file, the computer peripheral device writes the default configuration file as the smart home appliance configuration file to the temporary storage unit.

According to still another embodiment of the present disclosure, a smart home appliance control method includes: importing a program by connecting a computer peripheral device; after the computer peripheral device is connected to the computer, an embedded program of the computer is executed to write the smart home appliance configuration file into the temporary storage unit of the computer peripheral device.

With the above structure of the smart home appliance control method disclosed in the present disclosure, the user can operate the computer peripheral device to control various smart home appliances at home while using the computer, without having to find each smart home appliance one by one, or finding the remote control of the device or the touch panel operated in front of the smart home appliance, thus reducing the time spent by the user on the smart of the smart home appliance, and allowing the user to concentrate more on the to-do. In addition, through the peripheral devices of the computer and the embedded software running on the computer, the smart appliances can be manipulated in more detail, and the functions that the smart home controller cannot otherwise realize can be added, So that the smart home appliances can bring a more comfortable living experience to the user.

The above description of the disclosure and the following description of the embodiments of the present disclosure are intended to illustrate and explain the spirit and principles of the invention, and can give a further explain of the present disclosure.

### BRIEF DESCRIPTION OF THE DRAWINGS

The present disclosure will become more fully understood from the detailed description given here in below and the accompanying drawings which are given by way of illustration only and thus are not limitative of the present disclosure and wherein:

FIG. 1 is a schematic diagram of an application scenario illustrated by a method for controlling a smart home appliance according to an embodiment of the disclosure.

FIG. 2 is a main flowchart of a smart home appliance control method according to an embodiment of the disclosure.

FIG. 3 is a flow chart showing an import procedure in a smart home appliance control method according to an embodiment of the disclosure.

FIG. 4 is a flow chart showing an import procedure in a smart home appliance control method according to still another embodiment of the present disclosure.

FIG. 5 is a flow chart showing an import procedure in a smart home appliance control method according to still another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

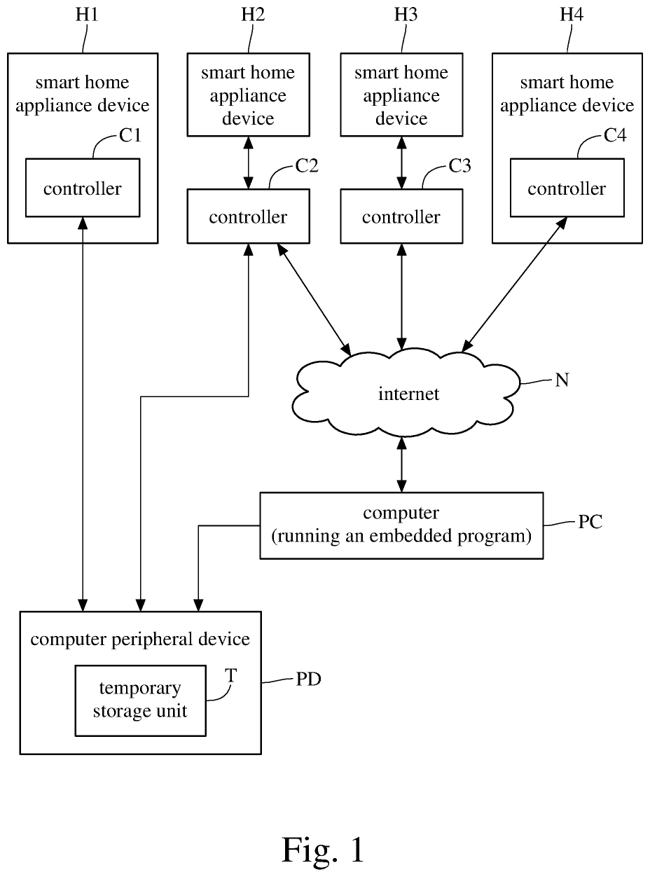

Please refer to FIG. 1, which is a schematic diagram of a scenario applicable to a method for controlling a smart home appliance according to an embodiment of the present disclosure. The smart home appliance control method according to an embodiment of the present disclosure is applied to the smart home appliances H1 to H4, the computer peripheral device PD, and the computer PC. Each of the smart home appliances H1 to H4 has its own controllers C1 to C4. The computer peripheral device PD can be directly connected to the controllers (such as C1 and C2) of some smart home appliances (such as H1 and H2). Alternatively, the computer peripheral device PD can be connected to a controller (such as C2˜C4) of some smart home appliances (such as H2˜H4) through an embedded program running on a computer PC, wherein the computer PC and these smart home appliances H2˜H4 are connected to a common network N, as shown in FIG. 1. In practice, some smart home appliances (such as H1 and H4) controllers (such as C1 and C4) are built into the smart home appliances H1 and H4, while some smart home appliances (such as H2 and H3) has a separate controller C2, C3.

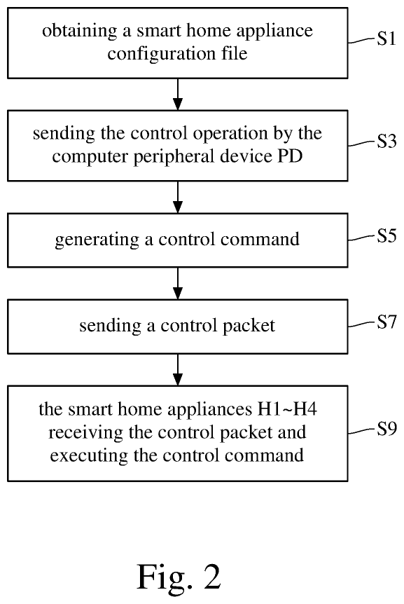

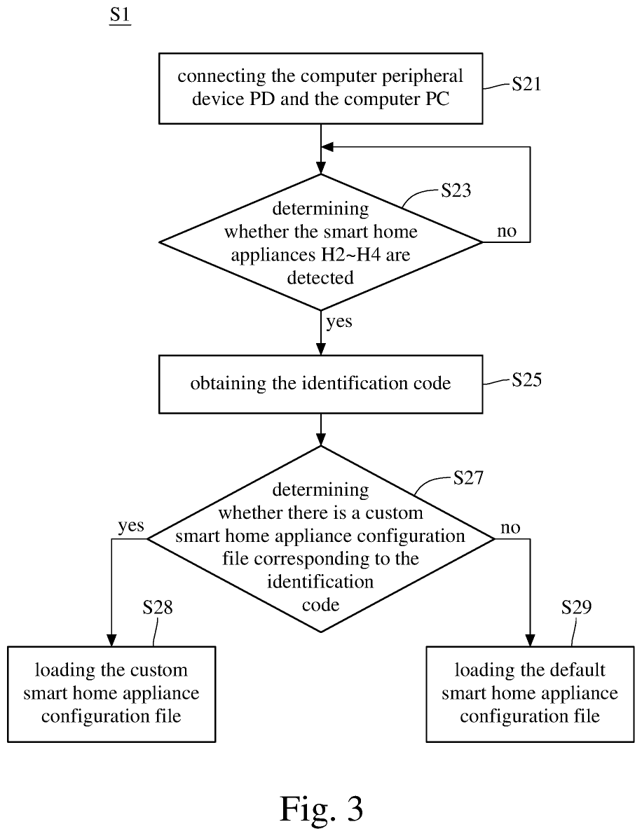

Please refer to FIG. 2, which is a main flowchart of a method for controlling a smart home appliance according to an embodiment of the disclosure. Please refer to step S1: obtaining a smart appliance configuration file. In detail, the computer peripheral device PD can execute an import program to obtain the smart home appliance configuration file from itself or from the computer PC. The so-called computer of the present disclosure refers to a host computer capable of executing a computer program, and is not limited to a conventional desktop or notebook computer, and includes other types of smart devices. The specific implementation steps of the importing program will be described in detail later when referring to FIGS. 3 to 5.

Please refer to step S3: the control operation is sent by the computer peripheral device PD. In practice, the computer peripheral device PD is, for example, a mouse, a keyboard, a touch panel, or a network camera. The present disclosure does not particularly limit the hardware type of the computer peripheral device PD. Therefore, the control operation that can be sent by the computer peripheral device PD as described above is, for example, a click/double click of a mouse button, a scrolling mouse wheel, pressing a specific key on the keyboard, a custom key, or a plurality of keys. The combination of a button, a touch gesture at a specific location, a specific body gesture for the webcam to capture the image, etc., does not limit the type of control operation. Basically, the control operation does not deviate from the usual usage of the original computer peripheral device PD. Therefore, the user can easily learn to control the control operation s of the smart home appliances H1 to H4.

Please refer to step S5 to generate a control command. Specifically, a processing unit searches for a corresponding control command in the smart home appliance profile acquired in step S1 according to the control operation acquired in step S3, and outputs the control command. The processing unit is, for example, a central processing unit located on a computer PC, or an embedded controller (EC), a microcontroller (Micro Control Unit (MCU), or a special application-specific integrated circuit (ASIC) located on the computer peripheral device PD. The disclosure does not particularly limit the hardware type of the processing unit.

Please refer to step S7 to send a control packet. In detail, a control packet is transmitted through a communication unit according to the control command obtained in step S5 and a communication protocol. The communication unit is, for example, a network interface card located in a computer PC or a signal transceiver located in the peripheral device PD of the computer. The hardware type of the communication unit of the present disclosure is not particularly limited. The communication protocol used in this step S7 is supported by at least one of the controllers C1 to C4 of the smart home appliances H1 to H4. In practice, for example, one or more of infrared communication technology (such as RC-5, VFIR, UFIR), Bluetooth (Bluetooth), Bluetooth Low Energy, ZigBee, ANT, wireless area network technology are used as the communication protocol used in this step S7.

Referring to step S9, the smart home appliances H1˜H4 receive the control packet and execute the control command. Specifically, the control packets transmitted by the communication unit in step S7 are received by the controllers C1 to C4 of the smart home appliances H1 to H4, respectively, and include control commands configured corresponding to the control operations of step S3. For example, click the left mouse button to switch the color temperature of the light, scroll the mouse wheel to adjust the brightness of the light, and so on. The controllers C1 to C4 extract control commands from the control packets, and the control commands include, for example, predetermined operation items, predetermined operation time, and detailed setting values of other home appliance control options. The present disclosure is also not particularly limited to the format and content of the control command.

Based on the flow shown in FIG. 1 in conjunction with the above description, a method of controlling a smart home appliance according to an embodiment of the present disclosure can be realized. Hereinafter, various acquisition modes of the smart home appliance profile described in step S1 of FIG. 1, that is, various embodiments of the aforementioned “importer program” will be described in sections, and these embodiments correspond to FIG. 3 to FIG. 5 respectively.

Please refer to step S1 and FIG. 3 of FIG. 2, which is a flowchart of an import procedure according to an embodiment of the present disclosure, which is applicable to a smart home appliance (such as H2 to H4 in FIG. 1) and a computer PC. An application scenario of the network N, as described above with respect to step S1, the importing program is used to obtain a smart appliance configuration file. Please refer to step S21: connecting the computer peripheral device PD and the computer PC. In detail, the computer peripheral device PD is connected to the computer PC by wire or wirelessly.

Please refer to step S23: determining whether the smart home appliances H2˜H4 are detected. In detail, an embedded program is executed on the computer PC, as shown in FIG. 1, and the embedded program is used to detect whether there are smart home appliances H2˜H4 connected to the network N. The embedded program can be started automatically after the computer is turned on, or after the step S21 is completed (that is, after confirming that the computer peripheral device PD is connected to the computer PC), the user can start it by itself or by the user. The present disclosure does not particularly limit the startup timing of the embedded program.

In practice, after step S21 and before step S23, that is, after the computer peripheral device PD is connected to the computer PC, the computer peripheral device PD may further include a serial number of the representative itself, the serial number being identified by the product, for example, product ID (PID) and vendor ID (VID ID). Thereby, the embedded program running on the computer PC can confirm whether it supports the computer peripheral device PD connected to the computer PC in step S21. In other words, the embedded program determines if the serial number is legal. If the serial number is legitimate, the subsequent step S25 of step S23 is continued. Otherwise, if the serial number is illegitimate, the peripheral device connected to the computer PC in step S21 is not supported, and therefore, the embedded program is terminated. Regarding whether the serial number is legitimate or not, in practice, for example, the embedded program checks whether the serial number or the serial number of the serial number is included in the database itself. However, the present disclosure does not particularly limit the mechanism for the embedded program to determine whether the serial number is legitimate.

Please refer to step S25: obtaining the identification code. In detail, the embedded program obtains an identification code of one of the smart home appliances H2 to H4 connected to the network N. In principle, each of the smart home appliances has an identification code, and the smart home appliance H2 is used as a representative of the plurality of smart home appliances H2 to H4. By means of the identification code obtained in step S25, the embedded program can recognize that the smart home appliance H2 connected to the network belongs to a certain appliance type and a specific model under this type.

Please refer to step S27: determining whether there is a custom smart home appliance configuration file corresponding to the identification code. Specifically, based on the identification code of the smart home appliance H2 acquired in step S25, the embedded program then searches for a custom smart home appliance profile that matches the identification code in a profile database. In practice, for example, the configuration file library can be first filtered according to the device type of the smart home appliance H2, and then the embedded program can be compared item by item according to the identification code to the filtered configuration file database. The correct method is not limited to the above.

If the result of the determination in step S27 is “YES”, there is a custom smart appliance configuration file corresponding to the identification code in the profile database; that is, the user has adjusted and stored the configuration file of the smart home device H2 as needed. Therefore, as shown in step S28, the embedded program loads the custom smart appliance configuration file. Conversely, if the result of the determination in the step S27 is “NO”, please refer to the step S29, when the custom smart home appliance profile of the smart home appliance H2 does not exist in the profile database, the embedded program loads a default smart appliance configuration file as the smart appliance configuration file. The default smart home appliance configuration file is, for example, that the user directly downloads the same type of smart home appliance configuration file from the manufacturer website of the smart home appliance device H2, or the smart home appliance configuration files that is pre-stored by the manufacturer in the computer peripheral device PD. In practice, when the embedded program is installed on a computer PC, a plurality of preset smart appliance configuration files matching various types of home appliances can be pre-loaded, so as to serve as a reference template before the user has customized the smart appliance configuration file. And the embedded program is also loaded in this step S29 for application in step S5 of FIG. 2.

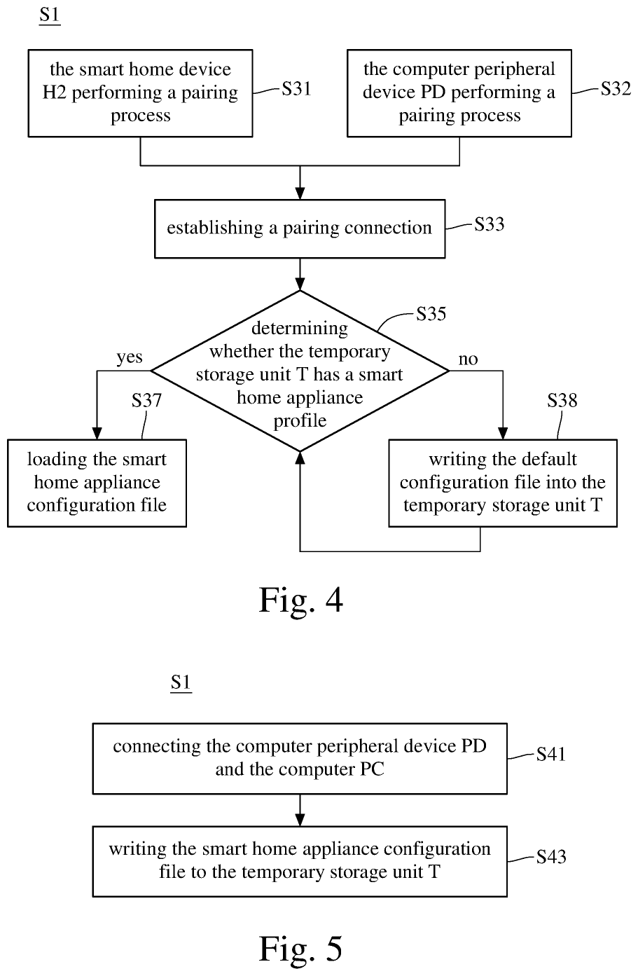

Please refer to step S1 and FIG. 4 of FIG. 2 together, which is a flowchart of an import procedure according to still another embodiment of the present disclosure. As described above with respect to step S1, the import program is used to obtain smart home appliance configuration files. Referring to steps S31 and S32 together, the computer peripheral device PD and the smart home device H2 each perform a pairing process. For example, the pairing program presses the pairing button to start the pairing program. The pairing button can be located only in the computer peripheral device PD, only in the smart home device H2, or in the above two (or other than the button). The mechanism for initiating the pairing procedure is not limited by the present disclosure; after the pairing procedure is started, for example, the paired broadcast signal is actively sent by the smart home appliance H2, and the computer peripheral device PD detects the paired broadcast signal and receives it. Recording, thereby establishing a pairing connection between the two, as shown in step S33. It should be noted that the host and object transmitted by the paired broadcast signal may also be interchanged. For example, the computer peripheral device PD sends a paired broadcast signal, and then the smart home device H2 detects and receives the paired broadcast signal.

Still another embodiment of the present disclosure is a state in which the computer peripheral device PD is directly connected to the smart home device H1 or H2. Please refer to FIG. 1 and step S35 of FIG. 4: determining whether the temporary storage unit T has a smart home appliance profile. In detail, for example, after one of the smart home appliance H2 or the computer peripheral device PD receives the paired broadcast signal and establishes a pairing connection, the computer peripheral device PD checks whether the temporary storage unit T of itself has the smart home appliance configuration file. When the temporary storage unit T does not have the smart appliance configuration file, the computer peripheral device PD writes a preset configuration file (for controlling H2) as the smart home appliance configuration file to the temporary storage unit T. The temporary storage unit T is, for example, a volatile memory. When the current is interrupted, the data stored in the temporary storage unit T disappears. In practice, the computer peripheral device PD using the import program shown in FIG. 4 belongs to a “dedicated” product, that is, a product designed for a smart home appliance device (such as H1 or H2) (relative to a “universal” product, it is suitable for a variety of smart home appliances). The computer peripheral device PD, which is a dedicated product, has been programmed into a non-volatile memory in the device before leaving the factory. Therefore, when the computer peripheral device PD confirms that the temporary storage unit T does not have a custom smart appliance configuration file, the preset smart home appliance configuration file stored in the non-volatile memory is written into the temporary storage unit T, As shown in step S38, the flow of the control command can be generated in accordance with the control operation in step S5 of FIG. 2. In this way, the user can directly start the function control after pairing the computer peripheral device PD with the smart home device H2. On the other hand, if it is confirmed that the user-defined smart home appliance profile exists in the temporary storage unit T, the smart home appliance profile can be directly loaded, as shown in step S37.

In addition, it should be additionally noted that the computer peripheral device PD can have a self-powered design. Thereby, the computer peripheral device PD can save the smart home appliance configuration file or the control command stored in the temporary storage unit T during the power-on period, until the power of the computer peripheral device PD is exhausted, or after the user turns off the power of the computer peripheral device PD. The data in the temporary storage unit T will be eliminated. In addition, when the computer peripheral device PD is connected to the computer PC, the embedded program will preferentially read the customized smart home appliance configuration file stored on the PC end of the computer and write it into the temporary storage unit T. Therefore, after the computer peripheral device PD is disconnected from the PC end of the computer, the control function of the customized smart home appliance saved in the temporary storage unit T can still achieve the same control effect as that of the computer PC, so in step S37 in FIG. 4, the loaded smart home appliance configuration file is the last smart home appliance file used by the user on the PC side of the computer. This method can effectively extend the dedicated computer peripheral device PD to achieve the control effect of the general-purpose computer peripheral device PD. Even without the assistance of the embedded program running on the computer PC, the single peripheral smart device H2 can be operated by the computer peripheral device PD alone.

Please refer to step S1 and FIG. 5 of FIG. 2 together, which is a flowchart of an import procedure according to still another embodiment of the present disclosure. As described above with respect to step S1, the import program is used to obtain smart home appliance configuration files. Please refer to step S41 to connect the computer peripheral device PD and the computer PC. This step is the same as step S21 of FIG. 3 and will not be described again here. Please continue to refer to step S43. After the computer peripheral device PD is connected to the computer PC, an embedded program is executed on the computer PC to write the smart home appliance configuration file to the temporary storage unit T of the computer peripheral device PD. The difference between the importing program of this embodiment and the foregoing embodiment is that the steps of the pairing procedure in FIG. 4 are omitted, and the latest smart home appliance configuration file is directly loaded from the PC end (which may be a custom smart home appliance configuration file set by the user. It may also be a default smart appliance configuration file stored on the PC side of the computer). The subsequent process after the completion of the import process continues to run on the computer peripheral device PD, instead of the embedded program running on the PC side of the computer as shown in FIG. 2.

Through the above description, the operation mode of the smart home appliance that can be implemented by the present disclosure is as follows:

(1) If the last controlled home appliance before the PD is electrically separated from the PC is H2, after the PD is electrically separated from the PC, the PD can individually control the operation of the H2 through the temporary storage unit T until the power of the PD is turned off.

(2) If the power of the PD is turned off and then turned back on, but the PC is not connected to the PC, the PD will re-pair the program according to the method shown in FIG. 4. If the factory-specific setting of the PD is H1, then after the connection, PD can directly control the operation of H1.

(3) If the PD is electrically connected to the PC, the operation of the PD is controlled by the embedded program of the PC, and the control signal of the smart home appliance is sent through the PC according to the steps of FIG. 2.

(4) If the PC is turned off and then turned back on, and the PD is electrically connected to the PC, the embedded program will reload the relevant smart home appliance configuration file according to the steps of FIG. 3, and the PD can start controlling the smart home appliance.

In summary, the control method of the smart home appliance disclosed in the foregoing embodiments of the present disclosure mainly uses the control protocol or the control interface reserved by the smart home appliance to transmit the control command, which can be executed on the computer. The embedded program combines with the computer peripheral device to instantly control various smart home appliances. It is also possible to achieve the effect of controlling the smart home appliance only by relying on the pairing connection between the computer peripheral device itself and the smart home appliance device. The smart home appliance configuration file includes a default configuration file or a user-defined configuration file, and the user can perform the configuration of the smart home appliance control item according to personal preference, and can also provide the default configuration file by downloading from the smart home appliance website or from the cloud database and apply it. In the control of smart home appliances, flexible and diversified control effects can be achieved, and the effect of turning on and off the smart home appliances such as scheduling control that cannot be achieved only by the remote controller can be increased. Because the medium of controlling is the computer peripheral device that the user is accustomed to, such as a mouse, a keyboard, etc., it is also quite easy for a novice user to use, and saves the user from finding another smart home appliance remote control or getting up and operating the smart home appliance. The time to maintain the user's concentration in front of the computer, improve the productivity of the work, or allow the game player to completely immerse in the game process without having to get up and running smart home appliances.

What is claimed is:

1. A control method for smart home appliance, with said control method applicable to a smart home appliance device, a computer peripheral device and a computer, and the control method comprising:
performing an import procedure to obtain a smart home appliance configuration file;
detecting a control operation by the computer peripheral device after obtaining the smart home appliance configuration file;
generating a control command according to the control operation and the smart home appliance configuration file by a processing unit;
transmitting a control packet according to the control command and a communication protocol by a communication unit; and
receiving the control packet by the smart home appliance and executing the control command in the control packet.

2. The control method for smart home appliance according to claim 1, wherein the smart home appliance and the computer are all communicably connected to a network, and the import procedure comprises:
connecting the computer with the peripheral device of the computer;
executing an embedded program by the computer and detecting whether there is a smart home appliance connected to the network by the embedded program;
obtaining an identification code of the smart home appliance connected to the network by the embedded program; and
checking whether there is a custom smart home appliance configuration file corresponding to the identification codes by the embedded program,
wherein the embedded program uses the custom smart home appliance configuration file as the smart home appliance configuration file when the custom smart home appliance configuration file exists, and the embedded program uses a default smart home appliance configuration file as the smart home appliance configuration file when the custom smart home appliance configuration file does not exist.

3. The control method for smart home appliance according to claim 1, wherein the import procedure comprises:
performing a pairing process between the computer peripheral device and the smart home appliance device to establish a pairing connection between the computer peripheral device and the smart home appliance device, wherein the pairing process includes:
selectively transmitting or receiving a paired broadcast signal;
establishing the pairing connection after receiving the paired broadcast signal; and
checking whether a temporary storage unit of one of the peripheral devices of the computer has the smart home appliance configuration file after the pairing connection is established;
wherein, when the temporary storage unit does not have the smart home appliance configuration file, the computer peripheral device writes a default configuration file as the smart home appliance configuration file to the temporary storage unit.

4. The control method for smart home appliance according to claim 1, wherein the import procedure comprises:
connecting the computer with the peripheral device of the computer; and
executing an embedded program of the computer to write the smart home appliance configuration file to a temporary storage unit of the computer peripheral device after the computer is connected to the computer peripheral device.

5. The control method for smart home appliance according to claim 2, wherein the import procedure comprises:
executing the embedded program of the computer to write the smart home appliance configuration file to a temporary storage unit of the computer peripheral device after the computer is connected to the computer peripheral device.

6. The control method for smart home appliance according to claim 2, wherein after the computer peripheral device is connected to the computer, the method further comprises:
sending a serial number for representing the user by the peripheral device of the computer; and
determining whether the serial number is legitimate by the embedded program, with obtaining the identification code of the smart home appliance connected to the network based on the embedded program when the serial number is determined to be legitimate, and terminating the embedded program when the serial number is determined to be illegitimate.

7. The control method for smart home appliance according to claim 1, wherein the computer peripheral device is a mouse, a keyboard, a touch pad or a webcam.

8. The control method for smart home appliance according to claim 4, wherein after the embedded program writes the smart home appliance configuration file to the temporary storage unit of the computer peripheral device, the method further comprises:
disconnecting an electrical connection between the computer and the computer peripheral device; and
operating the computer peripheral device to transmit the control operation by the smart home appliance configuration file in the temporary storage unit.

9. The control method for smart home appliance according to claim 1, wherein the communication unit is disposed in the computer.

10. The control method for smart home appliance according to claim 1, wherein the communication unit is disposed in the computer peripheral device.

11. The control method for smart home appliance according to claim 1, wherein the communication protocol is an infrared communication technology, a Bluetooth, a Bluetooth low energy, a Zigbee, or a wireless area network technology.
